(19) United States
(12) Patent Application Publication
(10) Pub. No.: US 2017/0219337 A1
(43) Pub. Date: Aug. 3, 2017

(54) CONDENSATION-ASSISTED METROLOGY

(71) Applicant: HGST Netherlands B.V., Amsterdam (NL)

(72) Inventors: Shahin Zangooie, San Jose, CA (US); Peter J. Wilkens, Los Gatos, CA (US)

(21) Appl. No.: 15/008,948

(22) Filed: Jan. 28, 2016

(51) Int. Cl. G01B 11/06; G01B 11/22

(52) U.S. Cl. CPC G01B 11/06; G01B 11/22

(57) ABSTRACT

An analysis chamber for an optical-metrology tool includes an enclosure having an opening oriented toward an optical-metrology specimen and aligned substantially parallel to the specimen; at least one transparent window arranged in the enclosure; at least one fluid inlet passing through the enclosure, the fluid inlet coupled to an analysis-fluid source; and an enclosure support configured to hold the enclosure above and in proximity to the specimen.

### BACKGROUND

Optical metrology may be used to examine a patterned semiconductor surface. Compared to competing metrology techniques, such as atomic-force microscopy, scanning- and tunneling-electron microscopies, and focused ion-beam methods, optical metrology is faster, less expensive, and uniquely non-destructive. Moreover, optical-metrology is extensible to biotechnology and to numerous other application areas. State-of-the-art optical-metrology, however, is typically indirect and model based. Certain strategies may be used to reduce model-induced parameter correlation problems and increase accuracy. These include multi-azimuth and parallel analysis (as described in U.S. Pat. No. 7,478,019), and hybrid metrology (as described in U.S. Patent Application Publication 2013/0203188 A1). These patent documents in their entirety are hereby incorporated by reference herein. Despite the benefits of optical metrology and its correlation-reducing variants, complex optical modeling may still lead to over-parameterization at very small length scales. To achieve the next quantum of precision, therefore, an increase in the number and quality of experimental observables is desirable.

### SUMMARY

One aspect of this disclosure is an analysis chamber for an optical-metrology tool. The analysis chamber includes: an enclosure having an opening oriented toward an optical-metrology specimen and aligned substantially parallel or parallel to the specimen; at least one transparent window arranged in the enclosure; at least one fluid inlet passing through the enclosure and coupled to an analysis-fluid source; and an enclosure support configured to hold the enclosure above and in close proximity to the specimen.

Another aspect is an optical-metrology tool. The optical metrology tool includes: a temperature-controlled stage configured to hold an optical-metrology specimen; an analysis-fluid source configured to release a current of carrier gas having a controlled partial pressure of a condensable vapor; an electronic controller operatively coupled to the temperature-controlled stage and to the analysis-fluid source; and an analysis chamber as described above.

Another aspect is an optical-metrology method. The method includes: flowing a carrier gas through an analysis chamber during a first optical assay of a specimen; entraining additional condensable vapor in the carrier gas, such that the partial pressure of the condensable vapor in the carrier gas is greater than during the first optical assay; and flowing the carrier gas with the additional entrained condensable vapor through the analysis chamber during a second optical assay of the specimen, the second optical assay being substantially parallel to the first optical assay.

The Summary above is provided to introduce a selected part of this disclosure in simplified form, not to identify key or essential features. The claimed subject matter, defined by the claims, is limited neither to the content of the Summary nor to implementations that address the problems or disadvantages noted herein.

### BRIEF DESCRIPTION OF THE DRAWINGS

This disclosure will be better understood from reading the following Detailed Description with reference to the attached drawing figures, wherein:

FIG. 1 shows aspects of an example optical-metrology tool;

FIGS. 2A, 2B, and 2C show aspects of an example analysis-chamber enclosure of an optical-metrology tool;

FIG. 3 provides an expanded view of an example analysis-fluid source of an optical-metrology tool;

FIG. 4 illustrates aspects of an example optical-metrology method;

FIG. 5 is a plot of the radius of the largest columnar structure filled with condensate at different partial pressures, according to the Kelvin equation; and

FIG. 6 shows aspects of a numerical simulation of an optical assay conducted on a condensate-filled specimen.

### DETAILED DESCRIPTION

As noted above, an increase in the number and quality of experimental observables is desirable in order to achieve greater precision and accuracy in optical metrology. Described herein is a new concept called Condensation Assisted Metrology (CAM), which employs capillary condensation effects to increase parameter sensitivity in various optical assays. In this technique, the surface topology of an optical-metrology specimen is temporarily filled during an assay with a liquid condensate, such as water, acetone or ethanol. In a manner dependent on the surface topology of the specimen, the condensate changes the optical-path properties of the specimen, which induces an observably different optical response than in the absence of the condensate. In the simplest example, the optical response at 100% partial pressure of the condensate, where the topologic structures are completely filled, is compared to the response at 0% partial pressure, where the topologic structures are completely empty. These two conditions may also be analyzed in parallel. Here, two or more sets of data may be analyzed simultaneously, with identical parameters coupled resulting in a simpler calculation by reducing the number of adjustable parameters. For instance the under-layer thicknesses, and/or side wall angles can be coupled, etc. In more complex examples, the specimen may be equilibrated to intermediate partial pressures of the condensable vapor—to fill some structures while leaving others vacant.

Aspects of this disclosure will now be described by example and with reference to the drawing figures listed above. Components, process steps, and other elements that may be substantially the same in one or more embodiments are identified coordinately and are described with minimal repetition. It will be noted, however, that elements identified coordinately may also differ to some degree. It will be further noted that the drawings included in this disclosure are schematic and generally not drawn to scale. Rather, the various drawing scales, aspect ratios, and numbers of components shown in the figures may be purposely distorted to make certain features or relationships easier to see.

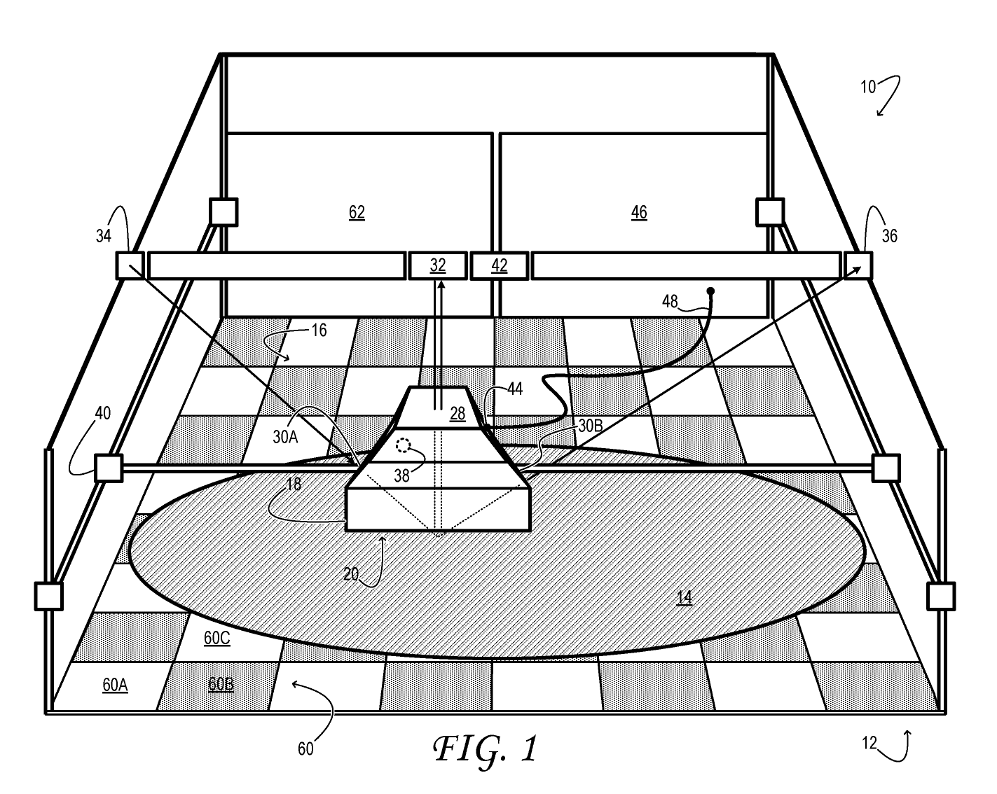

FIG. 1 is a perspective view of an example optical metrology tool 10 in one embodiment. The tool includes a temperature-controlled stage 12 configured to hold an optical-metrology specimen 14. The nature of the specimen is not particularly limited. In the illustrated embodiment, the specimen is substantially flat. In other words, the specimen may comprise very small aspect ratios relating depth to other dimensions. Nevertheless, the topologic features of the specimen, however shallow, may be targets for experimental observation using the tools and methods disclosed herein. In one non-limiting scenario, the specimen may be a patterned semiconductor (e.g., silicon) wafer. The topologic features to be studied may include epitaxial dielectric layers, conductive interconnects, thin films, etc.

Optical-metrology tool 10 of FIG. 1 includes analysis chamber 16. The analysis chamber includes a hollow and largely vacant enclosure 18 having an opening 20 oriented toward specimen 14 and aligned substantially parallel or parallel to the specimen. The analysis chamber may be used to blanket a target locus of the specimen in condensable vapor. In the illustrated embodiment, the analysis chamber covers only a limited area of the specimen, so that only a small portion of the specimen and tool are exposed to the condensable vapor. By contrast, the atmosphere above stage 12 may be dry and largely free of condensable vapor; it may be comprised of dry air or nitrogen in some implementations. Dosing only a small locus of the specimen with condensable vapor greatly reduces the equilibration time required for each optical assay and prevents unnecessary exposure of the primary optics and other components of tool 10 to the condensable vapor. In one embodiment, opening 20 may cover an area of the specimen of at least 2500 square millimeters (mm), and in other embodiments may cover an area of at least 50 square mm, and in other embodiments may cover an area that ranges between 50 square mm and 2500 square mm, and in other embodiments may cover an area that is greater than 2500 square mm. In a the depicted embodiment, the opening is shown as being square. Alternatively, the opening may be of another suitable shape.

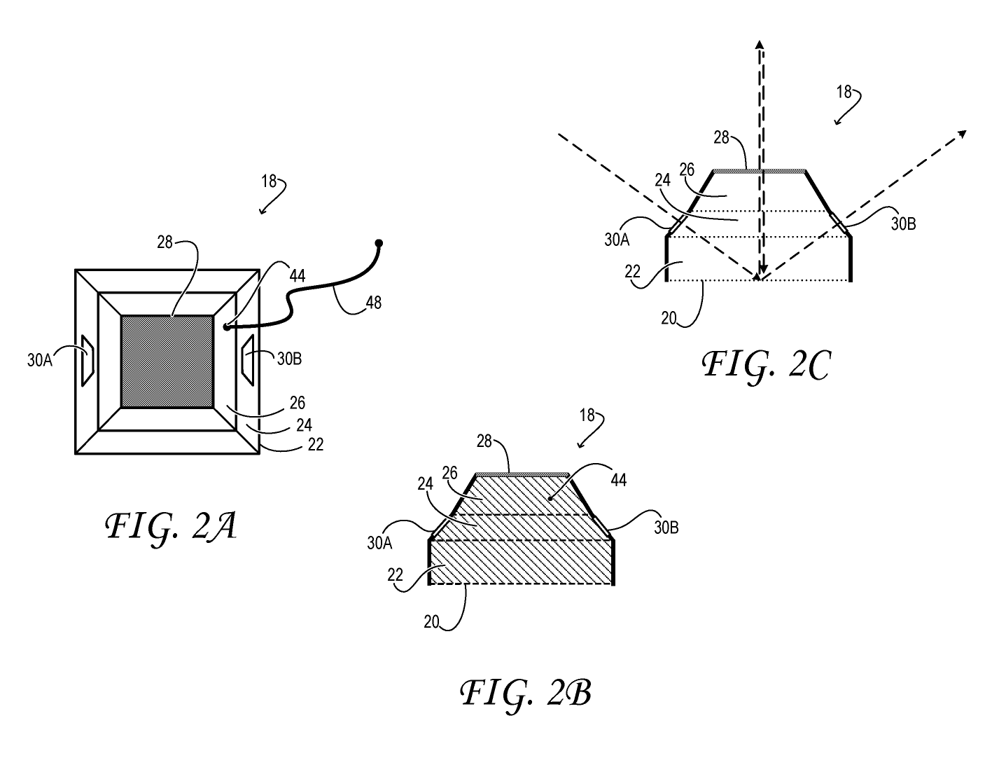

FIGS. 2A-C show additional views of enclosure 18 of analysis chamber 16 in one, non-limiting example. FIG. 2A is a plan view of the enclosure, FIG. 2B is a cutaway view, and FIG. 2C is a cross-sectional view. As shown in these drawings, opening portion 22 (the portion of enclosure 18 presenting opening 20) is a square prism open on the top and bottom. Arranged on top of the opening portion and in registry with the sides and corners of the opening portion is a first square pyramidal section 24—viz., the part of a square pyramid bounded by its base and by a plane substantially parallel or parallel to the base, and arranged between the base and the vertex. Like the opening portion of the enclosure, the first square pyramidal section is open on the top and bottom. At its top, the first square pyramidal section supports a second square pyramidal section 26 arranged in registry with the sides and corners of the first square pyramidal section. The second square pyramidal section is open at the bottom but closed at the top. In the illustrated embodiment, the top of the second pyramidal section is a transparent normal window 28, which permits the locus of the specimen below the enclosure to be assayed directly from above. The first square pyramidal section of the enclosure includes at least two transparent oblique windows 30A and 30B, through which the same locus can be assayed obliquely from above. It will be noted that the above geometric aspects are provided by way of example, and are not to be interpreted as limiting in any way, for numerous alternative enclosure geometries are envisaged as well.

More generally, at least one transparent window arranged in enclosure 18, to enable an optical metrology assay to be conducted on the locus of specimen 14 directly beneath the enclosure—the ‘target locus’ herein. In implementations in which the specimen is probed using ultraviolet (UV) and/or near infrared (NIR) light, the windows may be made of quartz. In alternative implementations, where only visible light is used, the windows may be made of high-quality optical glass. In some embodiments, the windows may support an anti-reflective (e.g., dichroic) coating.

Returning, now, to FIG. 1, normal window 28 of enclosure 18 is arranged substantially parallel or parallel to specimen 14 and the oblique windows—e.g., 30A, 30B—are arranged obliquely to the specimen. The normal and oblique windows enable illumination of the specimen by various probe beams and detection of reflected and/or scattered probe light from above the enclosure. In the illustrated embodiment, the normal window enables illumination and detection at normal incidence via collinear probe/detector 32. Oblique windows 30A and 30B enable illumination of the specimen at non-normal incidence by margin probe 34, and detection of reflected and/or scattered probe light via margin detector 36.

The window configuration in the illustrated embodiment allows 180° rotational symmetry to facilitate measurements in which the incidence and exit angles of the optical probe beam are substantially equal. In other embodiments, the rotational symmetry of the window configuration may be further extended—e.g., to 90°—by including windows also on the adjacent sides of the first square pyramidal section to support multiple angle-of-incidence measurements. In the embodiment illustrated in FIG. 1, optional temperature-control componentry 38 is arranged within enclosure 18 to prevent vapor condensate from fogging the windows under conditions in which the temperature of the windows falls below the dew point of the condensable vapor.

The probe and/or detector combinations of optical-metrology tool 10 support a range of optical assays in which probe light reflected or scattered from the target locus of specimen 14 is detected. Such detection may be angle-dispersive, wavelength-dispersive, and/or polarization-state dispersive. Accordingly, the range of optical-metrology assays envisaged herein include reflectometry, scatterometry, and film-thickness measurements based on ellipsometry. Straightforward imaging techniques may be used as well. These assays may be enacted separately or together.

As shown schematically in FIG. 1, optical-metrology tool 10 also includes an enclosure support 40. The enclosure support is configured to hold enclosure 18 above and in close proximity to specimen 14. In some embodiments, enclosure support 40 is an electronically movable support configured to move the enclosure in first and second (e.g., orthogonal) directions substantially parallel to or parallel to the specimen. In these and other embodiments, the enclosure support may be further configured to move the enclosure in a direction normal to the specimen (e.g., up and down). Alternatively, the enclosure support may hold the enclosure in a fixed position, and temperature-controlled stage 12 may be moved instead.

In the process of conducting an optical-metrology assay, enclosure 18 is brought in close proximity to specimen 14 without touching the specimen. The desired separation may be one millimeter, 100 micrometers, 10 micrometers, or 1 micrometer, depending on the implementation. In still other implementations, the enclosure may even contact the specimen under selected conditions, such as when preparations have been made to avoid damage to the specimen. For instance, a buffer zone may be arranged around the target test structure of the specimen, where the periphery of the enclosure can make contact. In implementations in which direct contact between the specimen and the enclosure is envisaged, a small thru-hole in the enclosure may be provided to avoid excessive pressurization of the enclosure. Automatically acquired reflectance data and/or auto-focus imaging data from camera 42 of optical-metrology tool 10 can be used to monitor the gap between the enclosure and the specimen. Alternatively, transmittance feedback from the probe beam passing through oblique windows 30 may be used to assess the spacing. As the enclosure approaches the specimen, eventually the oblique windows move into position to allow the probe beam from the margin probe to reach the margin detector. At that point, the enclosure is close enough to the specimen to begin the optical assay.

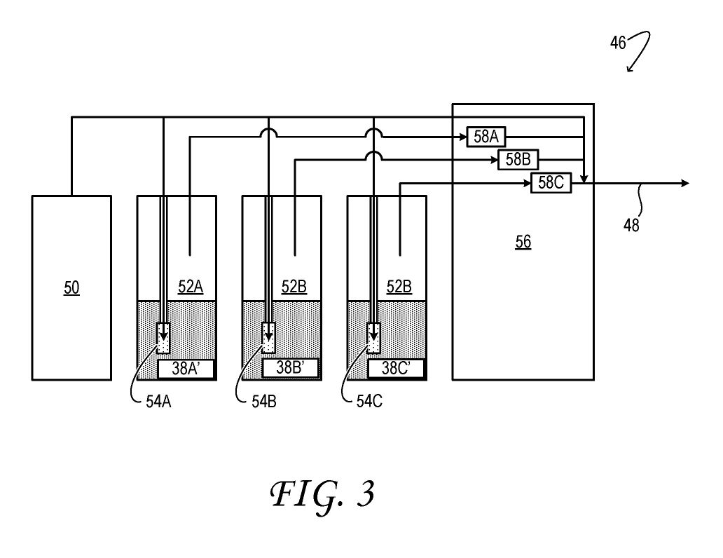

Continuing in FIG. 1, analysis chamber 16 includes at least one fluid inlet 44, which passes through enclosure 18. Coupled to an analysis-fluid source 46 by way of a flexible conduit 48, the fluid inlet supplies the analysis fluid to the locus of specimen 14 directly beneath the enclosure. The analysis fluid may include a carrier gas, which, under selected conditions, entrains a condensable vapor. Analysis-fluid source 46 is configured to release a current of carrier gas having a controlled partial pressure of the condensable vapor—water, acetone or ethanol, for example. FIG. 3 shows aspects of the analysis-fluid source in schematic detail. To entrain condensable vapor in a carrier gas, the analysis-fluid source may include dry carrier-gas source 50 and at least one saturated-vapor source 52. The carrier gas is typically purified air or nitrogen. In some embodiments, each saturated-vapor source may take the form of a bubbler charged with a volatile liquid and having a fritted glass inlet—54A, 54B, 54C, etc.—arranged below the surface of the volatile liquid. The volatile liquid may include water, acetone, or ethanol, for example. Temperature-control componentry 38A′, 38B′, and 38C′, etc., may be used to maintain the volatile liquid at a constant temperature despite thermal loss due to evaporation.

Each saturated-vapor source 52 produces a current of carrier gas which is substantially saturated in volatile liquid at the set-point temperature of the volatile liquid. From the saturated-vapor source, the vapor-saturated carrier gas flows to mixing chamber 56, where a controlled amount of the vapor-saturated carrier gas is combined with additional dry carrier gas from dry carrier-gas source 50. To provide accurate dosing of the vapor-saturated carrier gas into the dry carrier gas, the vapor-saturated carrier gas is directed through a mass-flow controller 58A, 58B, 58C, etc. In other embodiments, the dry carrier gas may be directed through a mass-flow controller. In still other embodiments, a proportional valve may be used in lieu of the mass-flow controller. In some embodiments, a mass-flow controller or proportional valve may be electronically controlled. In this manner, the analysis-fluid source may be configured to entrain any desired amount of condensable vapor in the carrier gas from a partial pressure of 0% to 100% saturation. Positive pressure within enclosure 18 ensures that the partial pressure of the condensable vapor remains substantially constant even though the carrier gas is continuously escaping the enclosure via the gap between the enclosure and the specimen.

Returning now to FIG. 1, temperature-controlled stage 12 includes a plurality of individually temperature-controlled zones 60 (e.g., 60A, 60B, 60C) coupled thermally to corresponding loci of specimen 14. Rather than lowering the temperature of the carrier gas to trigger faster condensation, optical-metrology tool 10 employs position-specific cooling and/or heating of the target loci of the specimen just prior to the optical assay. Cooling can be used for more efficient condensation, and heating can be used for more efficient drying of the specimen—viz., evaporation of condensate retained from a previous assay. In one embodiment, each of the plurality of temperature-controlled zones includes one or more Peltier elements configured to provide heating and/or cooling. In other embodiments, a series of fluid-carrying heat exchangers may be used. Electronic controller 62 is operatively coupled to the temperature-controlled stage and to analysis-fluid source 46, in order to provide the desired dosing of condensate on each target locus of the specimen. In some embodiments, the electronic controller may also control the movement of enclosure 18 via servoelectronic componentry of enclosure support 40. Accordingly, specific regions of the specimen can be thermally controlled using a program which is part of an overall metrology protocol. To this end, the electronic controller may include a processor, computer memory, and an input-output interface connected to each of the operatively coupled components. An extension of the illustrated configuration could include Peltier elements of opposite orientation in each zone. Localized cooling may be achieved by turning on the cold element or elements (elements with the cold side thermally coupled to the specimen). Localized heating is achieved by turning off the cold elements and turning on the hot element or elements (elements with the hot side thermally coupled to the specimen).

Between consecutive optical assays, optical-metrology tool 10 may be configured to switch from saturated flow to dry air to evaporate the condensate left behind from a previous assay. After such evaporation, analysis-fluid source 46 may generate a saturated flow using a different condensate (e.g., from water to acetone to ethanol). In other words, in embodiments in which a plurality of saturated vapor sources is provided, optical-metrology tool 10 may be configured to switch between the different condensates (which have different optical properties, naturally), to yield multiple data sets and further enhance the efficiency of parallel analysis. In some implementations, all stages of condensable vapor absorption and desorption may be monitored using reflectometry (normal incident) or ellipsometry (oblique incident) in real time. Accordingly, electronic controller 62 may be further coupled operatively to the various probe beam sources and detectors of the tool.

No aspect of the above description should be considered limiting in any way, for numerous other configurations are contemplated as well. In some implementations, for instance, the analysis fluid may be an aerosol of very small droplets of volatile liquid entrained in a carrier gas. In still other implementations, the analysis fluid may be delivered to the specimen in liquid form. Instead of the configuration shown in FIG. 1, an inverted geometry may be used, in which specimen 14 is suspended above analysis chamber 16.

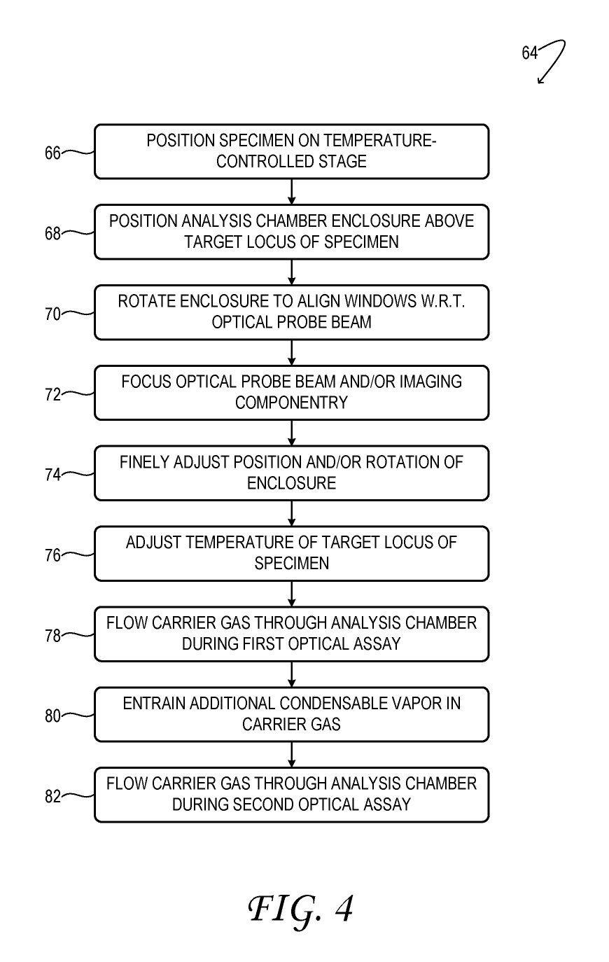

FIG. 4 shows aspects of an example optical-metrology method 64, which may be enacted using the optical-metrology tool described above. In some implementations, however, the method may be supported by other tools. At 66 of method 64, specimen 14 is positioned on temperature-controlled stage 12 and exposed to an optical probe beam and to the imaging componentry of optical-metrology tool 10. At 68 enclosure 18 is positioned directly above a pre-determined target locus of the specimen. At 70 the enclosure is rotated, if necessary, to align windows 28 and 30 to appropriate positions with respect to the optical probe beam. At 72 the optical probe beam and/or imaging componentry of the optical-metrology tool is focused. At 74 further adjustment (i.e., fine adjustment) to the position and/or rotation of the enclosure is made in order to ensure that the optical probe beam is passing through the windows. At 76 the temperature of a locus of the specimen beneath enclosure 18 is adjusted.

At 78 of method 64, carrier gas is flowed through the analysis chamber during a first optical assay of the specimen. In one embodiment, substantially none of the condensable vapor may be entrained in the carrier gas during the first optical assay. Accordingly, the flow of the carrier gas may serve to evaporate any condensate already deposited in the various features of the target locus of the specimen. At 80 additional condensable vapor is entrained in the carrier gas, such that a partial pressure of the condensable vapor in the carrier gas is greater than during the first optical assay. At 82 the carrier gas with the additional entrained condensable vapor is flowed through the analysis chamber during a second optical assay of the specimen. Typically, the second optical assay is essentially parallel to the first optical assay. In one embodiment, the carrier gas, during the second optical assay, is at least saturated in the condensable vapor at a temperature of a locus of the specimen beneath the enclosure.

No aspect of method 64 should be interpreted in a limiting sense, for numerous extensions, variations, and omissions are envisaged as well. For instance, the first and second optical assays referred to above may be among three or more substantially parallel or parallel optical assays conducted on the specimen in contact with the carrier gas entraining different amounts of condensable vapor. Thus, the method may be repeated for each of the desired partial pressures of entrained condensable vapor. Alternatively, the first and second optical assays referred to above may be among three or more substantially parallel or parallel optical assays conducted on the specimen in contact with the carrier gas entraining different kinds of condensable vapor (e.g., water, acetone, ethanol). Thus, the method may be repeated for each kind of condensate. Further, in some scenarios, entraining the additional condensable vapor at 80 may amount to selectively condensing volatile liquid into a topological feature of a first size while excluding the volatile liquid from a topological feature of a second, larger size. This aspect is better appreciated with reference to the Kelvin equation,

N_{A}kTpr ln x=−nMγ cos θ,

where N_{A} is Avogadro's constant, k is Boltzmann's constant, T is the absolute temperature, x is the partial pressure of the entrained condensable vapor, M is the molar mass of the condensable vapor, γ is the surface tension of the condensed condensable vapor, θ is the contact angle of the condensed condensable vapor on the specimen, p is the density of the condensed condensable vapor, r is the radius of the largest filled pore of the specimen, and n is a constant equal to one for cylindrical-shaped structures of the specimen.

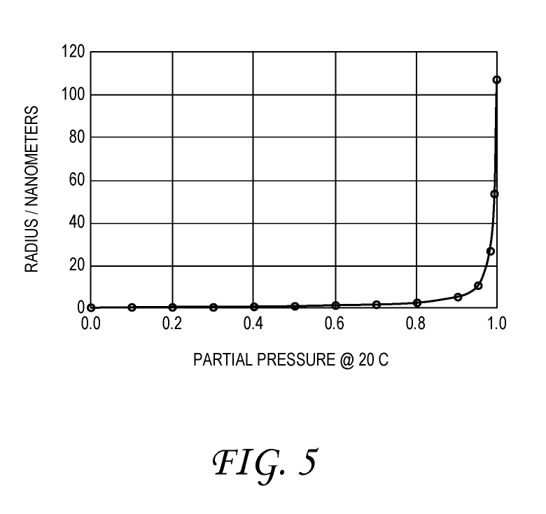

FIG. 5 shows the radius of the largest columnar structure filled with the condensate at different partial pressures. At saturation, all the structures are entirely filled with the condensate. The above equation demonstrates that the partial pressure x of the entrained condensable vapor is only one of several independent variables that may be adjusted in order to control the degree of filling of topologic structures of the specimen. The absolute temperature T also can be controlled, in addition to the quantity Mγ cos θ/p (by appropriate selection of the condensate, for a given specimen).

In addition to characterizing a patterned semiconductor surface, the CAM tools and methods described above can also be used for specific surface-area and pore-size distribution characterization of porous materials. The tools and methods may be used for genetics and for cell or bacterial growth studies in specimen arrangements similar to those described herein. Yet another type of investigation made accessible by the systems and methods herein is to use the temperature controlled stage to change the temperature of the specimen, perform an optical assay under the same environment (dry air, for example) before and after the temperature change, and thereby study the impact of the temperature change itself on the optical or structural properties of the surface. In addition, the temperature-controlled stage may be used to evaporate thin layers of water condensate before measurements with other tools, such as atomic force microscopy. Accordingly, the systems and methods disclosed herein are not strictly limited to optical assays.

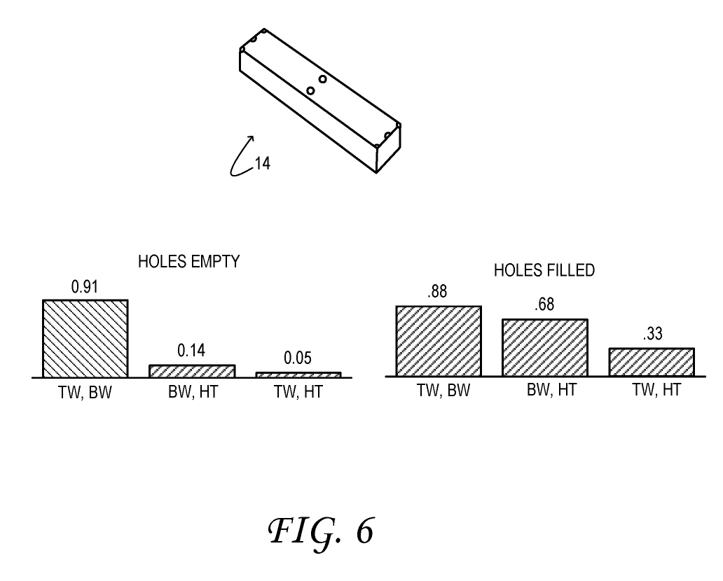

FIG. 6 shows results of a numerically simulated optical metrology analysis of a NiFe specimen 14, having a series of periodic holes. In this analysis, three different parameters are optimized: top width (TW), bottom width (BW), and height (HT), which corresponds to layer thickness. The simulation was run under two different conditions: first, when the periodic holes in the specimen are empty; and second, when the periodic holes are filled with water condensate. The optical response for the critical dimension (CD) measurement is different for the two conditions, as is the correlation between the various parameters.

In the graph of FIG. 6, the Y axis represents the correlation values of the fitted parameters. As shown in the graph, the correlation between TW and BW is lower when the holes are filled with water. In the case where the holes are empty, however, the correlation between width parameters and thickness is lower. Therefore, concurrent, parallel analysis of both conditions would yield a more accurate solution than either one individually. In the analysis, one may elect to weight a parameter more towards the most sensitive (desirable) condition.

It will be understood that the configurations and/or approaches described herein are presented for example, and that these specific examples or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of this disclosure includes all novel and nonobvious combinations and subcombinations of the various processes, systems and configurations, and other features, functions, acts, and/or properties disclosed herein, as well as any and all equivalents thereof.

1. An analysis chamber for an optical-metrology tool, the analysis chamber comprising:
an enclosure having an opening oriented toward a specimen and aligned parallel to the specimen;
at least one transparent window arranged in the enclosure;
at least one fluid inlet passing through the enclosure, the fluid inlet coupled to a fluid source; and
an enclosure support configured to hold the enclosure above and in proximity to the specimen.

2. The analysis chamber of claim 1 wherein the opening covers up to a 2500 square-millimeter area of the specimen.

3. The analysis chamber of claim 1 wherein the at least one transparent window includes a quartz window.

4. The analysis chamber of claim 1 wherein the at least one transparent window is oriented obliquely to the specimen, so as to enable illumination of the specimen from above the enclosure at non-normal incidence.

5. The analysis chamber of claim 1 further comprising temperature-control componentry arranged within the enclosure.

6. The analysis chamber of claim 1 wherein the enclosure support is an electronically movable support configured to move the enclosure in first and second directions substantially parallel to the specimen.

7. The analysis chamber of claim 6 wherein the enclosure support is further configured to move the enclosure normal to the specimen.

8. An optical-metrology tool comprising:
a temperature-controlled stage configured to hold a specimen;
a fluid source configured to release a current of carrier gas having a controlled partial pressure of a condensable vapor;
an electronic controller operatively coupled to the temperature-controlled stage and to the fluid source; and
an analysis chamber including an enclosure having an opening oriented toward the specimen and aligned substantially parallel to the specimen, at least one transparent window arranged in the enclosure, at least one fluid inlet passing through the enclosure, coupled to the fluid source, and an enclosure support configured to hold the enclosure above and in proximity to the specimen.

9. The optical-metrology tool of claim 8 wherein the temperature-controlled stage includes a plurality of individually temperature-controlled zones.

10. The optical-metrology tool of claim 9 wherein each of the plurality of temperature-controlled zones includes at least one Peltier element.

11. The optical-metrology tool of claim 8 wherein the fluid source includes at least one saturated-vapor source.

12. The optical-metrology tool of claim 8 wherein the fluid source includes at least one mass-flow controller.

13. The optical-metrology tool of claim 8 wherein the fluid source includes water, acetone, or ethanol.

14. An optical-metrology method comprising:
flowing a carrier gas through an analysis chamber during a first optical assay of a specimen, the analysis chamber including an enclosure having an opening oriented toward the specimen and aligned substantially parallel to the specimen, at least one transparent window arranged in the enclosure, at least one fluid inlet passing through the enclosure, coupled to a fluid source, and an enclosure support configured to hold the enclosure above and in proximity to the specimen;
entraining additional condensable vapor in the carrier gas, such that a partial pressure of the condensable vapor in the carrier gas is greater than during the first optical assay; and
flowing the carrier gas with the additional entrained condensable vapor through the analysis chamber during a second optical assay of the specimen, the second optical assay being substantially parallel to the first optical assay.

15. The optical-metrology method of claim 14 further comprising positioning the enclosure above a predetermined locus of the specimen.

16. The optical-metrology method of claim 14 wherein substantially none of the condensable vapor is entrained in the carrier gas during the first optical assay.

17. The optical-metrology method of claim 14 wherein during the second optical assay the carrier gas is at least saturated in the condensable vapor at a temperature of a locus of the specimen beneath the enclosure.

18. The optical-metrology method of claim 14 further comprising adjusting a temperature of a locus of the specimen beneath the enclosure.

19. The optical-metrology method of claim 14 wherein the first and second optical assays are among three or more substantially parallel optical assays conducted on the specimen in contact with the carrier gas entraining different amounts of the condensable vapor and/or different condensable vapors.

20. The optical-metrology method of claim 14 wherein entraining the additional condensable vapor includes selectively condensing a volatile liquid into a topological feature of a first size while excluding the volatile liquid from a topological feature of a second, larger size.
